(19) United States
(12) Patent Application Publication
(10) Pub. No.: US 2020/0282519 A1
(43) Pub. Date: Sep. 10, 2020

(54) STRINGED INSTRUMENT FRET FILING TOOL

(71) Applicant: STEWART-MACDONALD MANUFACTURING COMPANY, Athens, OH (US)

(72) Inventors: Jay Hostetler, Athens, OH (US); Don Macrostie, Athens, OH (US); Todd Sams, Athens, OH (US)

(73) Assignee: STEWART-MACDONALD MANUFACTURING COMPANY, Athens, OH (US)

(21) Appl. No.: 16/649,289

(22) PCT Filed: Sep. 20, 2018
(86) PCT No.: PCT/US18/51922

§ 371 Date: Mar. 20, 2020

Related U.S. Application Data
(60) Provisional application No. 62/561,451, filed on Sep. 21, 2017.

(51) Int. Cl. B24D 15/02; B24D 18/00; G10D 3/06

(52) U.S. Cl. CPC B24D 15/02; G10D 3/06; B24D 18/0018

(57) ABSTRACT

A stringed instrument fret filing tool and a method of making the fret filing tool. The fret filing tool includes a body having more than one major surface and numerous minor surfaces that defines a substantially planar profile. The planar profile is sized to a length that engages with three frets on a fretboard of a stringed instrument. Each of the minor surfaces defines a different length than the other minor surfaces. A file is formed on a middle portion along each of the lengths of the minor surfaces and opposing end portions are formed on the length of each minor surface and are disposed astride the file. During use of the fret filing tool, the file may glide along a raised fret and file the raised fret until it is the same height as the adjacent frets.

### CROSS-REFERENCE TO RELATED APPLICATIONS

This application claims priority to U.S. Provisional Patent Application Ser. No. 62/561,451 filed Sep. 21, 2017, which is incorporated by reference in its entirety.

### TECHNICAL FIELD

Embodiments of the present disclosure generally relate to a stringed instrument fret filing tool, and more particularly to a stringed instrument fret filing tool that can readily identify an uneven fret in a fretboard, as well as file the fret to a uniform height regardless of the position of the fret on the fretboard.

### BACKGROUND

When a string of a stringed instrument is plucked, the resulting vibration produces an audible sound with a frequency that depends on various factors such as string tension, string linear density and length. One common way to adjust the length—and hence frequency of vibration—is to place numerous frets along the elongate dimension of a fretboard that is situated underneath the string such that when the string is plucked while being relatively stationary at a particular fret, a vibration with a repeatable and identifiable frequency is produced. In order to produce a clear sound without causing a buzzing, tinging, or related dissonance, the frets on the fretboard should have an even height relative to one another. Frets are subjected to wear and, with prolonged use, have a tendency to deviate from the generally planar relationship they exhibit relative to one another when new. In particular when one fret projects higher out of the plane formed by the fretboard than the others, the vibrating string comes into contact with the higher fret, producing a dissonant sound.

Unfortunately, attempts at identifying and subsequently filing down a fret that may be the cause of string buzzing is an ad hoc process, as such height reduction may cure the problem for that particular fret, only to pop up in another (sometimes remote) fret. Such difficulty can turn a simple task into a laborious and frustrating one, and in an extreme case could result in overfiling a particular fret to the point where the entire fret or even fretboard may need to be replaced.

### SUMMARY

According to an embodiment of the present disclosure, a stringed instrument fret filing tool is disclosed. The fret filing tool includes a body made up of numerous major surfaces and numerous minor surfaces and each minor surface is substantially planar. The planar surface of each of the minor surfaces may come into contact with the frets in a fretboard. Each of the minor surfaces includes a length that is sized to span three frets on a fretboard of a stringed instrument. Each of the numerous minor surfaces is made up of a different length than the other minor surfaces. Each minor surface has a file formed on a middle portion. Opposing end portions are formed on the length of each of the minor surfaces and are located on either side of the file.

According to another embodiment of the present disclosure, a stringed instrument fret filing tool includes a four sided body made up of two major surfaces and four minor surfaces. Each minor surface has a different length: a first length, a second length, a third length, and a fourth length. Each minor surface also includes a middle portion, and two end portions. A file is located on the middle portion. The file may engage with a first fret while each end portion is engages with a second fret. The middle portion and each of the end portions are in the same plane.

According to yet another embodiment of the present disclosure, a method of making a stringed instrument fret filing tool includes obtaining a material that can be shaped into a body made up of numerous major and minor surfaces. Each of the minor surfaces has a middle portion with a file created thereon that can be used as a filing portion. A depth is cut into the middle portion of each minor surface. Diamond particles are electroplated into the depth until the depth is filled and minor surface is substantially planar, thereby forming the fret filing tool.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 shows an elevation view of a stringed instrument fret filing tool straddling three frets of a stringed musical instrument in accordance with one or more embodiments shown or described herein;

FIG. 2 is a perspective view of the stringed instrument fret filing tool of FIG. 1, illustrating a file in a middle portion of each of the respective minor surfaces;

FIGS. 3A through 3D show an in-use view of the stringed instrument fret filing tool of FIG. 1 as it is used at different intervals along the fretboard of a stringed instrument; and

FIG. 4 is an elevation view of a neck of a stringed instrument with a fretboard, in which one of the frets on the fretboard extends higher than the other frets.

The embodiments set forth in the drawings are illustrative in nature and not intended to be limiting to the claims. Moreover, individual features of the drawings will be more fully apparent and understood in view of the detailed description

### DETAILED DESCRIPTION

Specific embodiments of the present disclosure will now be described. The different embodied forms should not be construed as limited to the embodiments set forth herein. Rather, these embodiments are provided so that this disclosure will be thorough and complete, and will fully convey the scope of the present disclosure to those skilled in the art.

Unless otherwise defined, all technical and scientific terms used herein have the same meaning as commonly understood by one of ordinary skill in the art. The terminology used in the description herein is for describing particular embodiments only and is not intended to be limiting. As used in the specification and appended claims, the singular forms “a,” “an,” and “the” are intended to include the plural forms as well, unless the context clearly indicates otherwise.

Unless otherwise indicated, all numbers expressing distance, size, or other dimension that are modified by the term “about” as used in the specification and claims are to be understood to vary to the smallest significant figure. Additionally, the disclosure of any ranges in the specification and claims are to be understood as including the range itself and also anything subsumed within the range, as well as endpoints. Unless otherwise indicated, the numerical properties set forth in the specification and claims are approximations that may vary depending on the desired properties sought to be obtained in embodiments of the present disclosure. Notwithstanding that numerical ranges and parameters setting forth the broad scope of the disclosure are approximations, the numerical values set forth in the specific examples are reported as precisely as possible. Any numerical values, however, inherently contain certain errors necessarily resulting from error found in their respective measurements.

One or more embodiments of a stringed instrument fret filing tool (herein “fret filing tool”) according to this disclosure include a body having more than one major surface and numerous minor surfaces such that each minor surface defines a substantially planar fret-engaging profile along a length of the minor surface. The length of each minor surface is sized to engage with three frets on a fretboard of a stringed instrument and each length is a different length from the remaining minor surfaces. A file is formed on a middle portion on the length of each minor surface. The opposing end portions formed are disposed astride the file along the length of each minor surface. The opposing end portions are substantially planar to the file.

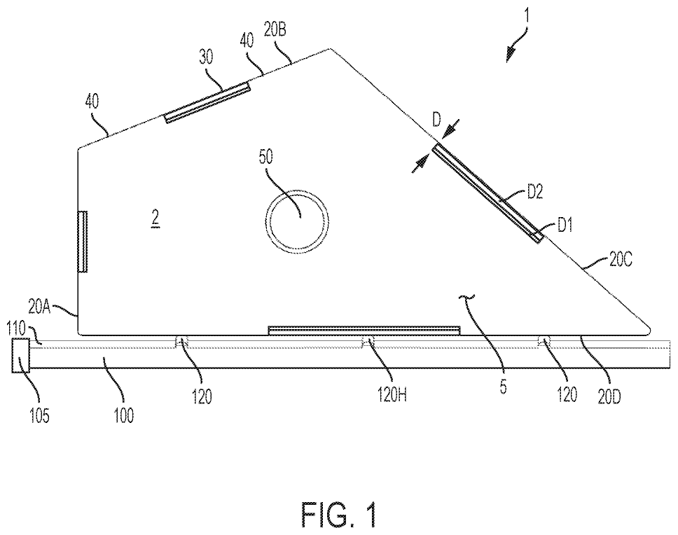

Referring first to FIG. 1, an illustration of a fret filing tool 1 according to an embodiment of this disclosure is shown engaging a portion of the neck 100 of a stringed instrument (notionally shown as a guitar). The fret filing tool 1 includes a quadrilateral body 2 having a plurality of major surfaces 5 and a plurality of minor surfaces 20A-D, in which each of the minor surfaces is of a different length than the others, defining a first length 20A, a second length 20B, a third length 20C, and a fourth length 20D.

The first length 20A is smaller than the second length 20B. The second length 20B is smaller than the third length 20C, and the fourth length 20D is larger than the first length, the second length 20B, and the third length 20C. In some embodiments, the first length 20A is about 1.0 inch to 1.5 inches, or 1.2 inches to 1.4 inches, and in some embodiments the first length 20A is about 1.3 inches. In one or more embodiments, the second length 20B is about 1.5 inches to 2.1 inches or 1.7 inches to 2.0 inches, and in some embodiments the second length 20B is about 1.9 inches. In one of more embodiments, the third length 20C is about 2.5 inches to 3.5 inches or 2.7 inches to 3.1 inches, and in some embodiments the third length 20C is about 3.0 inches. In one of more embodiments, the fourth length 20D is about 3.5 inches to 4.5 inches or 3.8 inches to 4.2 inches, and in some embodiments the fourth length 20D is about 4.0 inches.

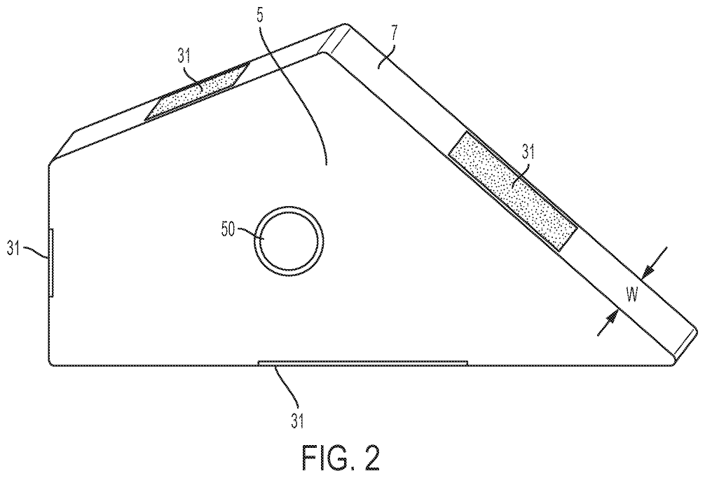

Each of the minor surfaces 7 includes a middle portion 30 and end portions 40. The middle portion 30 includes a file 31 that is shown in more detail in FIG. 2. The term “file” refers to a surface that cuts away or smoothes a fret. The term “file” may be used as a verb meaning to cut away or smooth. The file 31 may include electroplated diamond particles, which are deposited onto the body 2. Within the present context, the term “diamond particles” refers to crystallized material having a hardness from 7 to 10 on the Mohs scale of hardness regardless of the actual chemical makeup of such material. Examples of material used to form the diamond particles may include diamonds (with a hardness of 10), moissanite (with a hardness of 9.5), cubic zirconium (with a hardness of 8-8.5), or quartz (with a hardness of 7). In some embodiments, prior to electroplating the diamonds onto the body 2, a depth D is cut into the body 2. In one or more embodiments, a metal (such as nickel) is electroplated into the depth D, thereby creating a second depth D2. In FIG. 1, D1 corresponds to the thickness of the electroplated metal and a first depth. Once the metal is electroplated into the depth D to create a second depth D2, the diamond particles are electroplated onto the metal. In such embodiments, the depth D equals D1 plus D2. In another embodiment, a separate plating of metal need not be included such that the substantial entirety of D comprises the electroplated diamond particles.

Referring to FIG. 2, a perspective view of the fret filing tool 1 is shown. Each of the minor surfaces 7 defines a width W that defines the thickness between the major surfaces 5. In one form, the width W may be from about 0.1 to 1.0 inch, from about 0.2 to 0.5 inches, or in some embodiments may be about 0.25 inches. In one or more embodiments, the middle portion 30 is of from 20% to 50% based on each length of each side. In one or more embodiments, the plurality of major surfaces 5 defines a pair of opposing and substantially planar surfaces such that the minor surfaces 7 define an edge disposed between the pair of opposing and substantially planar surfaces.

One or more embodiments of this disclosure include methods of making a stringed instrument fret filing tool. In some embodiments, a shaping material is provided and formed into the body 2 that includes a plurality of major surfaces 5 and a plurality of minor surfaces 7, wherein each minor surface 7 includes a middle portion 30 and a length that spans at least three frets of a fretted stringed instrument. A depth is cut into the middle portion 30 of each minor surface 7. Diamond particles are electroplated or electrodeposited into the depth to form the fret filing tool 1. When the diamond particles are added to the depth D, the depth D is filled and each minor surface 7 becomes substantially planar across both of the middle and end portions 30, 40. As used in this disclosure, the terms “electroplating” and “electrodepositing” are used interchangeably.

In another embodiment, a shaping material is provided and formed into the body 2 that includes a plurality of major surfaces 5 and a plurality of minor surfaces 7, wherein each minor surface 7 includes a middle portion 30 and a length that spans at least three frets of a fretted stringed instrument. A depth is cut into the middle portion 30 of each minor surface 7. A metal plating is added to the depth D, thereby forming a second depth D2. Diamond particles are electroplated or electrodeposited into the second depth D2 to form the fret filing tool 1. When the diamond particles are added to the second depth D2, the second depth D2 is filled and each minor surface 7 becomes substantially planar across both of the middle and end portions 30, 40.

In one or more embodiments, the metal plating used to plate or coat the first depth may be any metal that conducts a current, such as nickel, copper, gold, aluminum, zinc, brass, or iron. The metal plating may have a thickness less than 0.002 inch or may be from approximately 0.001 inch to approximately 5 μm. The first depth is from approximately 0.01 to 0.02 inches. The second depth equals the first depth minus the thickness of the metal plating. The metal plating and the diamond particles may be added through various electrodepositing methods such as pulse electroplating, brush electroplating, or electrochemical deposition.

In one or more embodiments, a thin layer of metal is depositing into the first depth of the middle portion 30 of each minor surface 7 of the fret filing tool 1 using electrolysis to form the metal plating. After the first depth is coated with the metal plating to form a second depth, the diamond particles are electroplated into the second depth. Diamond particles may be suspended in a metal plating solution. As a current is conducted through the metal plating in the first depth, the diamond particles and metal plating solution are deposited on the metal plating. The metal plating in the first depth is connected to a circuit and functions as a cathode. The metal plating is submerged into the metal plating solution, and, as the metal is deposited, the diamond particles are occluded in the plating. The diamond particles are added until the second depth is filled, causing each minor surface 7 to become substantially planar.

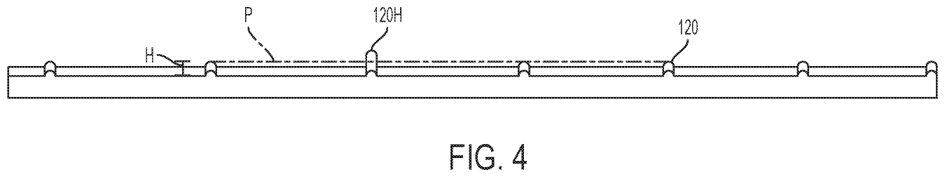

Referring again to FIG. 1 in conjunction with FIG. 4, in one or more embodiments, the body 2 and file 31 define a unitary construction. The term “unitary construction” means single item (such that the file 31) is incorporated into or onto the body 2 such that the entire fret filing tool 1 is a single piece rather than being an assembly of many secondary components. By maintaining the exposed surface of the file 31 in a macroscopically planar form, and further making it coplanar with the end portions 40, the file 31 in the middle portion 30 can be made to file a higher fret 120H and the end portions 40 are engaged with the frets 120 on either side of fret engaged with the middle portion 30. In one form, the file 31 is applied by electroplating diamond particles onto each of the middle portions 30.

In one or more embodiments of the fret filing tool, the body 2 includes a bore 50 disposed in the body 2 of the tool and extended through the width of the tool. The bore 50 may increase ease of handling and storing the fret filing tool 1. In some embodiments, the apexes of the fret filing tool 1 are smooth or slightly rounded, which may also increase ease of handling.

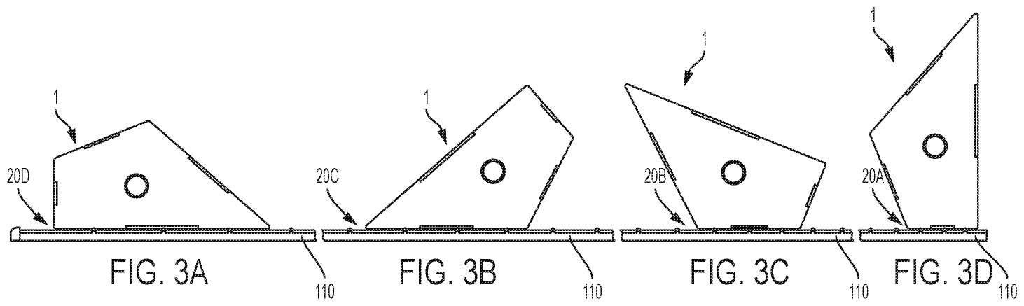

Referring to FIGS. 3A through 3D, each length of the fret filing tool 1 corresponds to a different location along the fretboard 110 of a stringed instrument. For example, on a fret board of a guitar, the frets 120 are spaced according to conventionally even tampering (that is to say when progressing from the nut 105 toward the bridge each successive fret is closer to the bridge by a factor of the 12^{th} root of 2 or a number when multiplied by itself twelve times equals two). There are twelve frets to an octave, and the pitch at the octave is twice that of the open string, the 12^{th} root of two simply divides the octave into 12 logarithmically equal parts. This explains why the frets are further apart closer to the nut 105 and closer together near the body of the guitar. The minor surface corresponding to fourth length 20D may be used along the fretboard 110 closer to the head of a guitar. As such, in use, the minor surface 7 corresponding to the first length 20A may be used along the fretboard 110 closer to the body of a guitar. By taking advantage of these varying lengths, ease of use of tool 1 is promoted, especially as it relates to having tool 1 straddle three consecutive frets 120 on the fret board 110 to help ensure that a planar and even filing optimization ensues.

A person skilled in the art should recognize that in one form the neck of a stringed instrument may have no relief, thereby having no curve along the length of the neck. In such configurations when there is no relief, the height H of the frets 120 on the fret board 110 should be in the same plane, thus the frets 120 have the same height. However, based on an artist's preference, the relief of the stringed instrument may be adjusted without needing to fine-tune the height of the frets. If a fret 120H is too high in comparison to the other frets 120 on the fretboard 110 of a stringed instrument, the instrument may not produce the best sound. However, identifying the fret causing the poor sound quality on stringed instruments having more than one fret may be difficult as usual inspection may not provide the necessary degree of precision. Additionally, the fret filing tool 1 according to one or more embodiments of this disclosure can be used to identify an unlevel fret. The term “unlevel,” as used herein, means higher comparison to the immediately adjacent frets such that together the tops of the frets do not define a planar projection relative to the fretboard 110 as a hole. As shown in FIG. 3, each length of the fret filing tool 1 is sized to fit over three frets 120 on the fretboard 110. When one of the three frets 120 is unlevel the tool 1 is not balanced and rocks.

Once a high fret 120H is identified, the fret or frets can be filed to an even height. As shown in FIG. 3, one of the four lengths of the fret filing tool 10 spans three frets. The file 31 that is in the same plane as the end portion 40 engages with the higher fret 120H while the end portion 40 engages with the fret 120 on either side of the unlevel fret. The higher fret 120H projects above an imaginary planar surface P defined by the three successive frets 120 as shown in FIG. 4. Gripping the major surfaces 5 between the thumb and forefinger, a person can glide the fret filing tool 1 parallel to the elongate dimension of the frets 120 (that is, across the width of the neck that makes up the fretboard 110) and the higher fret 120H in a forwards and backwards motion that is side-to-side relative to the width of the neck 100 of the stringed instrument. The file 31 files the higher fret 120H until it is even with the frets 120 or in the imaginary planar surface P. Since the file 31 is in the same plane as each end portion 40, a person does not need a measuring tool or another tool to ensure that the fret 120H is not filed too low. As soon as the once unlevel fret 120H is of the same height as the other two frets, the middle portion 30 may engage with the once unlevel fret 120H, but does not file the fret 120H.

The fret filing tool 1 according to one or more embodiments has multiple functions, which decreases the number of tools a person requires to make or fix a stringed instrument. Due to the multiple functionalities, the fret filing tool 1 increases the ease at which an unlevel fret 120H can be modified. Instead of switching between two or three tools because of the various spacing between the adjacent frets 120 of the guitars and other stringed instruments, a person can use one tool to identify the problem fret 120H, file the problem fret 120H, and check the previously unleveled fret 120H to determine whether it was level based on the two adjacent frets 120 has been achieved.

In some embodiments, the methods of making the fret filing tool 1 include forming a piece of metal or other hard material into a body 2 which has numerous major surfaces 5 and more than one minor surface 7. Such forming may be through known techniques, such as casting, forging, or the like. Each of the minor surfaces 7 has a middle portion 30 and a length 20A-D that can straddle three frets 120. A file 31 is applied to each of the middle portions 30 to form the stringed instrument fret filing tool 1. The metal may include, but not limited to, alloys such as stainless steel (SS) 304 and SS 316 or tool grade steel. The file 31 may be formed by depositing a second material onto the body 2, such as electrodepositing or electroplating. The second material may be diamond particles or a material having a hardness greater than the frets 120. The frets may have a hardness of approximately 100 on the Rockwell B scale. When the file 31 is made up of electroplated diamond particles, the material of the body may be any hardness.

It should be apparent to those skilled in the art that various modifications can be made to the described embodiments without departing from the spirit and scope of the claimed subject matter. Thus, it is intended that the specification cover modifications and variations of the described embodiments provided such modification and variations come within the scope of the appended claims and their equivalences.

1.-13. (canceled)

14. A stringed instrument fret filing tool comprising:
a body comprising a plurality of major surfaces and a plurality of minor surfaces, wherein the plurality of minor surfaces:
are disposed between the plurality of major surfaces;
define one width and at least four different lengths such that each length can engage with three frets on a fretboard of a stringed instrument; and
are substantially planar; and
a file disposed on each of the minor surfaces such that the file defines a middle portion disposed between end portions, wherein the file of a particular one of the plurality of minor surfaces is configured to file a raised fret when the particular one of the plurality of minor surfaces is engaged with three frets;
wherein the stringed instrument fret filing tool has a unitary construction that is configured to identify the raised fret and file the raised fret.

15. A method of making a stringed instrument fret filing tool, the method comprising:
providing a shaping material;
forming the shaping material into a body comprising a plurality of major surfaces and plurality minor surfaces, wherein each minor surface comprises a middle portion and a length that spans at least three frets of a fretted stringed instrument;
cutting a depth into the middle portion of each minor surface; and
electrodepositing diamond particles into the depth to form the fret filing tool, wherein the depth is filled and each minor surface is substantially planar across both of the middle and end portions.

16. The method of claim 15, further comprising adding a metal plating to the depth to form a second depth prior to electrodepositing the diamond particles into the second depth to form the fret filing tool.

17. The method of claim 16, wherein the metal is chosen from nickel, copper, gold, aluminum, zinc, brass, or iron.

18. The method of claim 16, wherein the metal is from 0.001 to 0.005 inches thick.

19. The method of claim 16, wherein the first depth is from 0.01 to 0.02 inches deep.

20. The method of claim 15, wherein the diamond particles are chosen from diamonds, moissanite, cubic zirconium, or quartz.

21. The stringed instrument fret filing tool according to claim 14, wherein the file comprises diamond particle teeth.

22. The stringed instrument fret filing tool according to claim 14, wherein at least one length is from about 1.0 inch to about 1.5 inches.

23. The stringed instrument fret filing tool according to claim 14, wherein at least one length is from about 1.5 inches to about 2.1 inches.

24. The stringed instrument fret filing tool according to claim 14, wherein at least one length is from about 2.5 inches to about 3.5 inches.

25. The stringed instrument fret filing tool according to claim 14, wherein at least one length is from about 3.5 inches to about 4.5 inches.

26. The stringed instrument fret filing tool according to claim 14, wherein the body further comprises a width of from 0.1 to 1.0 inch.

27. The stringed instrument fret filing tool according to claim 14, wherein the middle portion comprises between about 20% to 50% of the length of each side.

28. The stringed instrument fret filing tool according to claim 14, the tool further comprising a bore disposed in the body.

29. The stringed instrument fret filing tool according to claim 14, wherein the body and the file define a unitary construction.

30. The stringed instrument fret filing tool according to claim 14, wherein the plurality of major surfaces defines a pair of opposing and substantially planar surfaces.

31. The stringed instrument fret filing tool according to claim 14, wherein each of the minor surfaces defines an edge disposed between the pair of opposing and substantially planar surfaces.
